(19) United States
(12) Patent Application Publication
(10) Pub. No.: US 2011/0294500 A1
(43) Pub. Date: Dec. 1, 2011

(54) POWER SAVING METHOD OF MOBILE DEVICE AND COMMUNICATION SYSTEM THEREOF

(75) Inventors: Chia-Hsiang Chang, Taipei City (TW); Chih-Hsun Chou, Taipei County (TW); Yen-Chieh Cheng, Taipei City (TW); Yu-Chun Pan, Taipei County (TW)

(73) Assignee: INSTITUTE FOR INFORMATION INDUSTRY, Taipei (TW)

(21) Appl. No.: 12/881,184

(22) Filed: Sep. 14, 2010

(30) Foreign Application Priority Data
May 28, 2010 (TW) 99117179

(51) Int. Cl. H04W 4/00; H04B 7/00

(52) U.S. Cl. 455/426.1; 455/522

(57) ABSTRACT

A power saving method adaptable to a mobile device in a travel-by-vehicle environment is provided. A connection is established between the mobile device and a communication device according to a first communication protocol, and a connection is established between an access point and the communication device according to a second communication protocol, wherein the transmission power required in the first communication protocol is lower than that required in the second communication protocol. If a connection established according to the second communication protocol exists between the mobile device and the access point, the connection established between the mobile device and the access point according to the second communication protocol is cut off. An operation interface of the mobile device is provided to a user so that the mobile device communicates with the access point through the communication device.

### CROSS-REFERENCE TO RELATED APPLICATION

This application claims the priority benefit of Taiwan application serial No. 99117179, filed on May 28, 2010. The entirety of the above-mentioned patent application is hereby incorporated by reference herein and made a part of this specification.

### BACKGROUND OF THE INVENTION

1. Field of the Invention

The present invention generally relates to a power saving method of a mobile device and a communication system thereof, and more particularly, to a power saving method adaptable to a mobile device in a travel-by-vehicle environment (i.e. the environment which a user travels by a vehicle) and a communication system thereof.

2. Description of Related Art

The wireless communication technology has been well developed in recent years. Mobile devices can communicate with each other through access points. Thus, a user can use a mobile device to communicate with others or surf the Internet. However, sometimes a user may want to connect his mobile device to a device in a transportation vehicle when the user is travelling by the transportation vehicle.

For example, a common mobile device for playing music can be connected to a communication device in a transportation vehicle. After the mobile device is connected to the communication device in the transportation vehicle, the communication device in the transportation vehicle can play multimedia files stored in the mobile device. In the other example, the communication device and the mobile device may also share the application programs stored therein through this connection. After connecting the mobile device to the communication device in the transportation vehicle, the user cannot operate through the operation interface of the mobile device. Instead, the user has to operate through the operation interface of the communication device in the transportation vehicle.

However, different communication devices in different transportation vehicles have different operation interfaces. Thus, the user has to adapt himself to a new operation interface every time when the user enters a transportation vehicle and connects his mobile device to the communication device in the transportation vehicle. Such a situation is very inconvenient to the user.

In addition, in order to allow the user to use the functions of his mobile device through the communication device in the transportation vehicle, the manufacturer of the communication device in the transportation vehicle has to develop an operation interface adaptable to the mobile device of the user and application software supporting the functions of the mobile device. As a result, the manufacturer of the communication device has to spend the development cost of the application software and the operation interface.

Moreover, the communication device in the transportation vehicle may further offer a wireless communication function such that it can be connected with the mobile device in a wireless manner. FIG. 1 is a diagram illustrating the connection between a communication device and a mobile device in a transportation vehicle. Referring to FIG. 1, the transportation vehicle may be a car, and the communication device 102 may be a vehicle gateway. When the user enters the vehicle environment, the user can use the mobile device 100 (for example, a 3G cell phone) to establish a Bluetooth connection with the communication device 102 according to the Bluetooth communication protocol. Besides, the communication device 102 itself can communicate with an access point 104. For example, the communication device 102 establishes a cellular network connection with the access point 104 according to the wireless fidelity (WiFi) protocol.

When the user needs to communicate (for example, browse a webpage) with the access point 104 by using the mobile device 100, the user has to operate the operation interface of the communication device 102 to communicate with the access point 140. After that, the access point 104 transmits data of the webpage to be browsed by the user to the communication device 102, and then the communication device 102 transmits the data to the mobile device 100 through the Bluetooth connection.

In the infrastructure illustrated in FIG. 1, the communication device 102 works as a client, and the mobile device 100 works as a server. Namely, the communication device 102 is an initiator which instructs the mobile device 100 to execute different functions. The communication device 102 requests a subscriber identity module (SIM) profile from the mobile device 100. After that, the communication device 102 can execute different operations or applications on behalf of the mobile device 100. However, because some other information of the mobile device 100 besides the SIM profile may be required for executing some operations or applications of the mobile device 100, the manufacturer of the communication device 102 has to modify some specific applications of the communication device 102 with respect to different operations or applications of the mobile device 100 in order to allow the communication device 102 to execute all the operations or applications of the mobile device 100.

In summary, regarding the designs and applications of conventional communication devices (for example, gateways or integrated devices) in transportation vehicles and related techniques, a user has to adapt himself to a new operation environment every time when the user enters a vehicle environment. Namely, the user uses different functions of a mobile device through an operation interface of a vehicle gateway.

### SUMMARY OF THE INVENTION

According to an exemplary embodiment of the present invention, a power saving method adaptable to a mobile device in a travel-by-vehicle environment is provided. A connection is established between the mobile device and a communication device according to a first communication protocol, and a connection is established between an access point and the communication device according to a second communication protocol, wherein the transmission power required in the first communication protocol is lower than that required in the second communication protocol. If a connection established according to the second communication protocol exists between the mobile device and the access point, the connection established between the mobile device and the access point according to the second communication protocol is cut off. An operation interface of the mobile device is provided to a user to operate, such that the mobile device communicates with the access point through the communication device.

According to an exemplary embodiment of the present invention, a non-volatile storage medium is provided for storing a plurality of program codes, wherein the program codes are executed to run the power saving method described above.

According to an exemplary embodiment of the present invention, a mobile device adaptable to a travel-by-vehicle environment is provided. The mobile device includes an operation interface, a control module, and a dual mode communication module. The dual mode communication module is capable of establishing a connection according to a first communication protocol or a second communication protocol, wherein the transmission power required in the first communication protocol is lower than that required in the second communication protocol. When the mobile device enters the travel-by-vehicle environment, the control module controls the dual mode communication module to establish a connection between the mobile device and a communication device according to the first communication protocol. If a connection established according to the second communication protocol exists between the mobile device and an access point, the control module controls the dual mode communication module to cut off the connection established according to the second communication protocol between the mobile device and the access point. An operation interface is operated by a user so that the mobile device communicates with the access point through the communication device, wherein a connection is established between the communication device and the access point according to the second communication protocol.

According to an exemplary embodiment of the present invention, a communication device adaptable to a travel-by-vehicle environment is provided. The communication device includes a translation module and a dual mode communication module. The dual mode communication module is capable of establishing a connection according to a first communication protocol or a second communication protocol, wherein the transmission power required in the first communication protocol is lower than that required in the second communication protocol. When a mobile device enters the travel-by-vehicle environment, the dual mode communication module establishes a connection between the mobile device and the communication device according to the first communication protocol. The dual mode communication module establishes a connection between an access point and the communication device according to the second communication protocol. After cutting off a connection established according to the second communication protocol between the mobile device and the access point, an operation interface of the mobile device is operated by a user so that the mobile device communicates with the access point through the communication device, and the translation module relays a first communication data from the mobile device to the access point and relays a second communication data from the access point to the mobile device.

According to an exemplary embodiment of the present invention, a communication device adaptable to a travel-by-vehicle environment is provided. The communication device includes a wake-up module and a dual mode communication module. The dual mode communication module is capable of establishing a connection according to a first communication protocol or a second communication protocol, wherein the transmission power required in the first communication protocol is lower than that required in the second communication protocol. When a mobile device enters the travel-by-vehicle environment, the dual mode communication module establishes a connection between the mobile device and the communication device according to the first communication protocol. The dual mode communication module establishes a connection between an access point and the communication device according to the second communication protocol. After cutting off a connection established according to the second communication protocol between the mobile device and the access point, an operation interface of the mobile device is operated by a user so that the mobile device communicates with the access point through the communication device. When the communication device receives a calling message from the access point, the wake-up module generates a wake-up message according to the calling message and sends the wake-up message to the mobile device.

According to an exemplary embodiment of the present invention, a communication system including an access point, a communication device, and a mobile device is provided, wherein the communication device and the mobile device are located in a travel-by-vehicle environment. The mobile device and the communication device establish a connection with each other according to a first communication protocol, and the communication device and the access point establish a connection with each other according to a second communication protocol, wherein the transmission power required in the first communication protocol is lower than that required in the second communication protocol. If a connection established according to the second communication protocol exists between the mobile device and the access point, the connection established according to the second communication protocol between the mobile device and the access point is cut off. An operation interface of the mobile device is operated by a user so that the mobile device communicates with the access point through the communication device.

As described above, exemplary embodiments of the present invention provide a power saving method of a mobile device and a communication system thereof. By using the power saving method, the power consumption of the mobile device is reduced, and a user is allowed to use an operation interface of the mobile device in a travel-by-vehicle environment without changing his operation habit. Thereby, the operation of the user is made very convenient and less power is consumed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the connection between a communication device and a mobile device in a transportation vehicle.

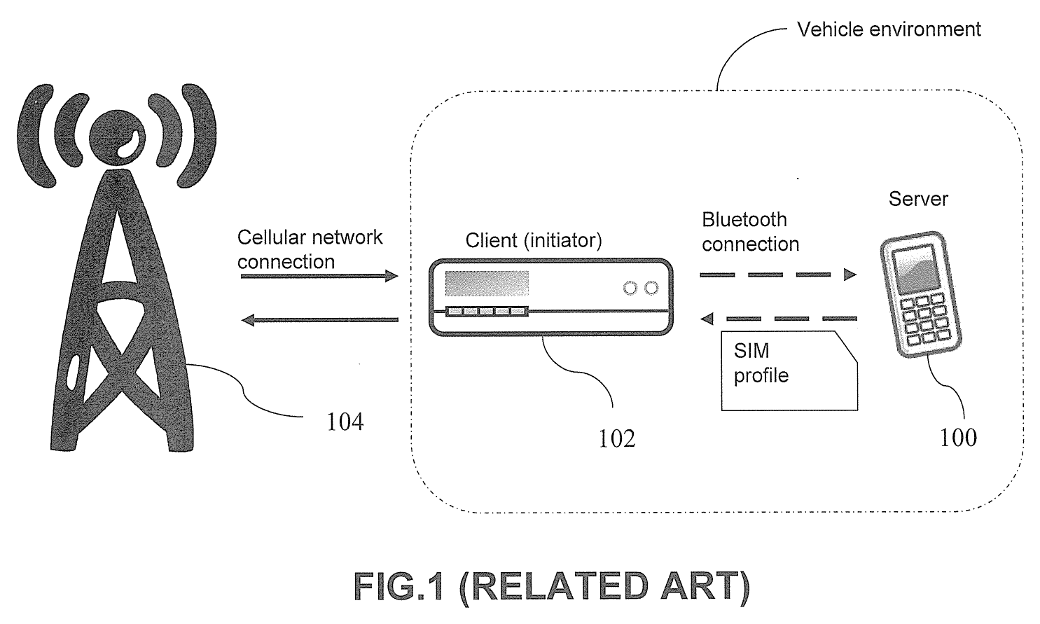

FIG. 2 is a diagram illustrating the connection between a communication device and a mobile device in a transportation vehicle according to an exemplary embodiment of the present invention.

FIG. 3 is a flowchart of a power saving method of a mobile device according to an exemplary embodiment of the present invention.

FIG. 4 is a block diagram of a vehicle gateway supporting the power saving method in FIG. 3.

FIG. 5 is a block diagram of a cell phone supporting the power saving method in FIG. 3.

FIG. 6 is a flowchart of a power saving method of a mobile device according to another exemplary embodiment of the present invention.

FIG. 7 is a block diagram of a vehicle gateway supporting the power saving method in FIG. 6.

FIG. 8 is a block diagram of a cell phone supporting the power saving method in FIG. 6.

FIG. 9 is a block diagram of a cell phone supporting both the power saving method in FIG. 3 and the power saving method in FIG. 6.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In an exemplary embodiment of the present invention, a communication device (for example, a vehicle gateway) adaptable to a travel-by-vehicle environment is provided such that a user can use a mobile device without changing his operation habit. Meanwhile, a short distance connection can be transparently established between the mobile device and the communication device, such that the mobile device can use the medium/long distance communication resources in the communication device without altering the original application programs in the mobile device. To be specific, exemplary embodiments of the present invention provide an innovative application scenario, wherein a mobile device is used in a travel-by-vehicle environment, and a user can operate an operation interface of the mobile device to allow the mobile device to communicate with an access point through a communication device, such that the user can use different functions of the mobile device.

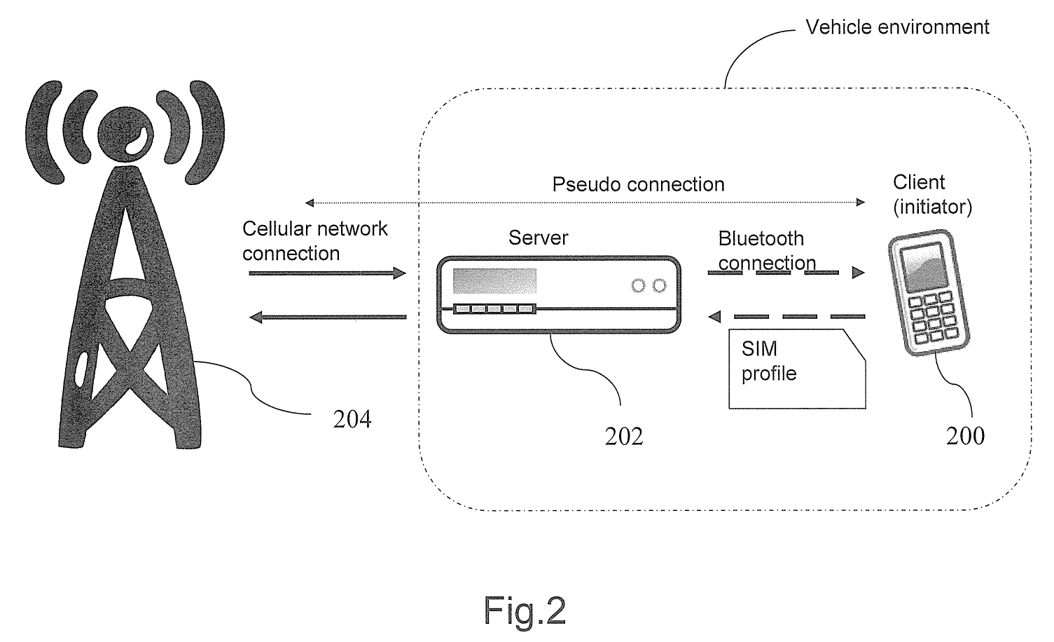

FIG. 2 is a diagram illustrating the connection between a communication device and a mobile device in a transportation vehicle according to an exemplary embodiment of the present invention. Referring to FIG. 2, the communication system includes a mobile device 200, a communication device 202, and an access point 204. The mobile device 200 is located in a travel-by-vehicle environment, and the communication device 202 is disposed in a transportation vehicle (i.e., in the travel-by-vehicle environment) for communicating with the access point 204. The mobile device 200 may be a flat panel computer, a cell phone, or a personal digital assistant (PDA). The transportation vehicle may be a bus, a car, a train, a ferry, or an airplane. The travel-by-vehicle environment may be a vehicle environment, a ferry environment, or an airplane environment. The communication device 202 may be a gateway, a proxy server, or a repeater.

The mobile device 200 and the communication device 202 respectively have a dual mode communication module and a control module. The mobile device 200 further has an operation interface. The dual mode communication module is capable of establishing a connection according to a first communication protocol and a second communication protocol. The control module manages the connection established according to the first communication protocol or the second communication protocol. The control module may be implemented as a hardware circuit or a software program. It is more economical to keep the hardware circuit of the mobile device unchanged and implement the control module as a software program. For example, an existing mobile device 200 usually has a processing unit and a storage unit. The storage unit stores a plurality of program codes, and the processing unit reads these program codes, so as to control the dual mode communication module and the operation interface.

In FIG. 2, when a user gets on the transportation vehicle, the mobile device 200 and the communication device 202 establish a connection with each other according to the first communication protocol. The communication device 202 and the access point 204 establish a connection with each other according to the second communication protocol. This connection may be established after the connection between the mobile device 200 and the communication device 202 is established according to the first communication protocol. In the other exemplary embodiment, this connection may already exist before the connection between the mobile device 200 and the communication device 202 is established according to the first communication protocol.

The transmission power required in the first communication protocol is lower than that required in the second communication protocol. The first communication protocol may be a short distance wireless communication protocol, and the second communication protocol may be a medium/long distance wireless communication protocol. The short distance wireless communication protocol may be the wireless USB transmission protocol, the far infrared transmission protocol, the infrared transmission protocol, or the Bluetooth communication protocol. The medium/long distance wireless communication protocol may be the wireless fidelity (WiFi) communication protocol, the GSM communication protocol, the GPRS communication protocol, the EDGE communication protocol, the 3G mobile communication protocol, or the HSDPA communication protocol.

Generally speaking, a connection established according to the second communication protocol exists between the mobile device 200 and the access point 204 before the user enters the travel-by-vehicle environment. Thus, when the user enters the vehicle environment, the connection established between the mobile device 200 and the access point 204 according to the second communication protocol is cut off. For example, after the communication device 202 and the mobile device 200 establishes a connection according to the first communication protocol, the communication device 202 notifies the mobile device 200 to cut off the connection established between the mobile device 200 and the access point 204 according to the second communication protocol.

The method and time for cutting off the connection established between the mobile device 200 and the access point 204 according to the second communication protocol described above are not intended to limit the present invention, and can be changed according to the actual requirement by the manufacturers of the mobile device 200 and the communication device 202. For example, the mobile device 200 automatically cuts off the connection established between the mobile device 200 and the access point 204 according to the second communication protocol after the communication device 202 and the mobile device 200 establish the connection according to the first communication protocol. For example, the communication device 202 automatically cuts off the connection established between the mobile device 200 and the access point 204 according to the second communication protocol before the communication device 202 and the mobile device 200 establish the connection according to the first communication protocol.

In the connection between the mobile device 200 and the communication device 202 illustrated in FIG. 2, the mobile device 200 works as a client, and the communication device 202 works as a server. In other words, the mobile device 200 works as an initiator which instructs the mobile device 200 to execute different functions, and the communication device 202 simply works as an agent between the access point 204 and the mobile device 200. The user directly use different application programs of the mobile device 200 by operating an operation interface of the mobile device 200, and thus the mobile device 200 communicates with the access point 204 through the connection between the communication device 202 and the access point 204.

To be specific, in the step of establishing the connection between the mobile device 200 and the communication device 202, the communication device 202 obtains a subscriber identity module (SIM) profile of the mobile device 200 and related user data from the mobile device 200, and the communication device 202 transparently relays the SIM profile and the related user data to the access point 204. Thus, the communication device 202 can pose as the mobile device 200, and the access point 204 can consider the communication device 202 as the mobile device 200.

The power saving method illustrated FIG. 2 may be implemented as a software program. Namely, the steps described above are expressed with program codes, and the communication device 202 and the mobile device 200 execute these program codes to run the power saving method illustrated in FIG. 2. The program codes may be written into a non-volatile storage medium, such as a CD, a flash drive, a hard disc, or a memory card.

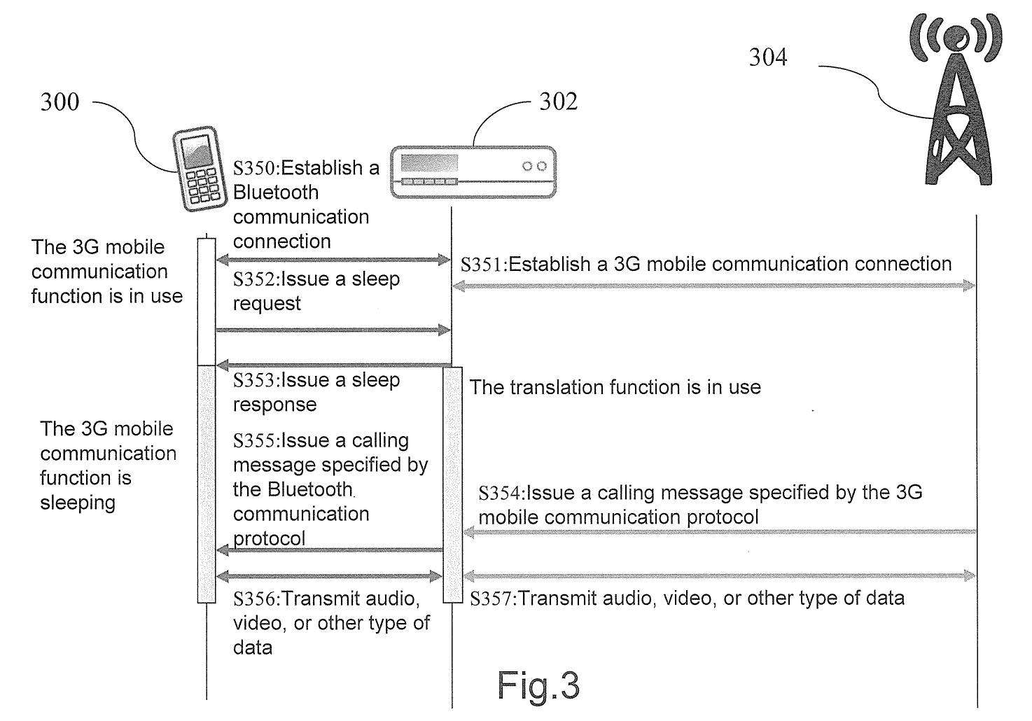

FIG. 3 is a flowchart of a power saving method of a mobile device according to an exemplary embodiment of the present invention. Referring to FIG. 3, when a cell phone 300 enters a vehicle environment, a connection between the cell phone 300 and a vehicle gateway 302 is established according to the Bluetooth communication protocol (step S350). To be specific, when the connection is established, the vehicle gateway 302 obtains a SIM profile of the cell phone 300 and related user data from the cell phone 300. After that, a connection between the vehicle gateway 302 and an access point 304 is established according to the 3G mobile communication protocol (step S351). The execution sequence of the steps S350 and S351 is not limited in the present invention and can be swapped.

Next, a sleep request is issued by the cell phone 300 to the vehicle gateway 302 (step S352). After the sleep request is received, a sleep response is issued by the vehicle gateway 302 to the cell phone 300 (step S353). After the sleep response is received by the cell phone 300, the connection between the cell phone 300 and the access point 304 established according to the 3G mobile communication protocol is cut off (i.e., a 3G mobile communication module of the cell phone 300 switches from a working state to a sleep state). Because the vehicle gateway 302 has the SIM profile of the cell phone 300 and the related user data, the vehicle gateway 302 poses as the cell phone 300 and the access point 304 considers the vehicle gateway 302 as the cell phone 300.

It should be noted that the steps S352 and S353 are not intended to limit the present invention. In other words, there are other methods for cutting off the connection between the cell phone 300 and the access point 304 established according to the 3G mobile communication protocol. For example, in another exemplary embodiment, the vehicle gateway 302 directly issues a sleep message to the cell phone 300 to instruct the cell phone 300 to cut off the connection between the cell phone 300 and the access point 304 established according to the 3G mobile communication protocol. In yet another exemplary embodiment, the cell phone 300 may also directly cut off the connection between the cell phone 300 and the access point 304 established according to the 3G mobile communication protocol.

Thereafter, if the access point 304 is about to communicate with the cell phone 300, a calling message specified by the 3G mobile communication protocol is issued by the access point 304 to the vehicle gateway 302 (step S354). After the vehicle gateway 302 receives the calling message from the access point 304, a calling message specified by the Bluetooth communication protocol is issued by the vehicle gateway 302 to the cell phone 300 (step S355). Next, audio, video, or other type of data is transmitted by the cell phone 300 to the vehicle gateway 302 through the connection established between the cell phone 300 and the vehicle gateway 302 according to the Bluetooth communication protocol (step S356). Similarly, audio, video, or other type of data is transmitted by the vehicle gateway 302 to the cell phone 300 through the connection established between the vehicle gateway 302 and the cell phone 300 according to the Bluetooth communication protocol (step S356). Audio, video, or other type of data is transmitted by the vehicle gateway 302 to the access point 304 through the connection established between the vehicle gateway 302 and the access point 304 according to the 3G mobile communication protocol (step S357). Similarly, audio, video, or other type of data is transmitted by the access point 304 to the vehicle gateway 302 through the connection established between the access point 304 and the vehicle gateway 302 according to the 3G mobile communication protocol (step S357).

In the example described above, the vehicle gateway 302 has to convert the format of the audio, video, or other type of data of the Bluetooth communication protocol into a format specified by the 3G mobile communication protocol and transmits the converted audio, video, or other type of data to the access point 304. Similarly, the vehicle gateway 302 has to convert the format of the audio, video, or other type of data of the 3G mobile communication protocol into a format specified by the Bluetooth communication protocol and transmits the converted audio, video, or other type of data to the cell phone 300.

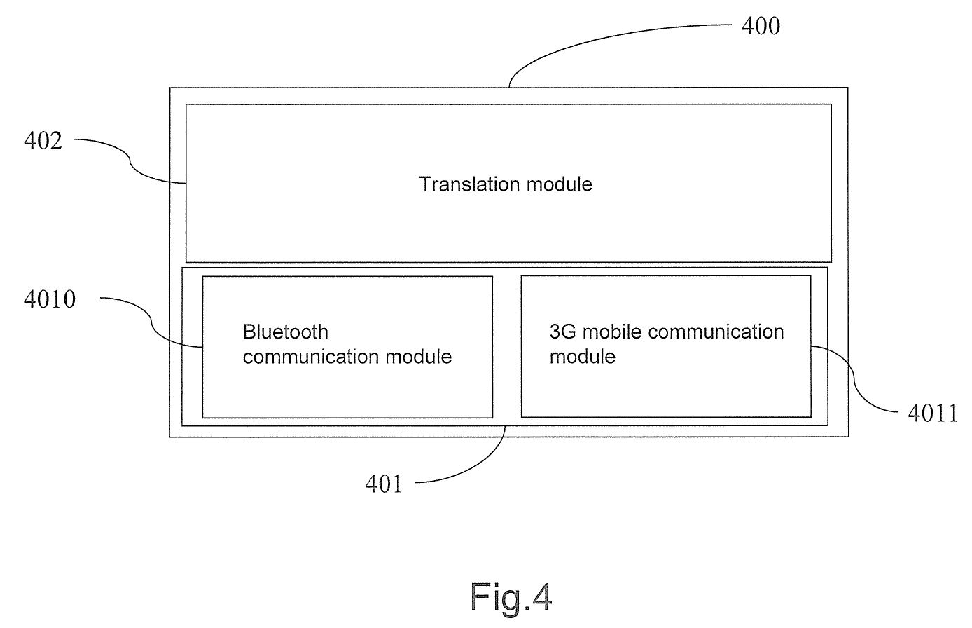

FIG. 4 is a block diagram of a vehicle gateway supporting the power saving method in FIG. 3. Referring to FIG. 4, the vehicle gateway 400 includes a dual mode communication module 401 and a translation module 402. The dual mode communication module 401 has a Bluetooth communication module 4010 and a 3G mobile communication protocol module 4011. The Bluetooth communication module 4010 is capable of establishing a connection according to the Bluetooth communication protocol, and the 3G mobile communication protocol module 4011 is capable of establishing a connection according to the 3G mobile communication protocol. When a cell phone enters a travel-by-vehicle environment, the Bluetooth communication module 4010 establishes a connection between the cell phone and the vehicle gateway 400 according to the Bluetooth communication protocol, and the 3G mobile communication protocol module 4011 establishes a connection between an access point and the vehicle gateway 400 according to the 3G mobile communication protocol. After cutting off a connection established according to the 3G mobile communication protocol between the cell phone and the access point, a user operates the operation interface of the cell phone to allow the cell phone to communicate with the access point through the vehicle gateway 400.

The translation module 402 relays communication data from the cell phone to the access point and from the access point to the cell phone. To be specific, the translation module 402 converts the format of communication data transmitted by the cell phone into a format specified by the 3G mobile communication protocol and transmits the converted communication data to the access point. The translation module 402 also converts the format of communication data transmitted by the access point into a format specified by the Bluetooth communication protocol and transmits the converted communication data to the cell phone.

The translation module 402 may be implemented as a hardware circuit or a software program. For example, an existing vehicle gateway 400 usually has a processing unit and a storage unit. The storage unit stores a plurality of program codes, and the processing unit reads and executes these program codes to accomplish the functions of the translation module 402.

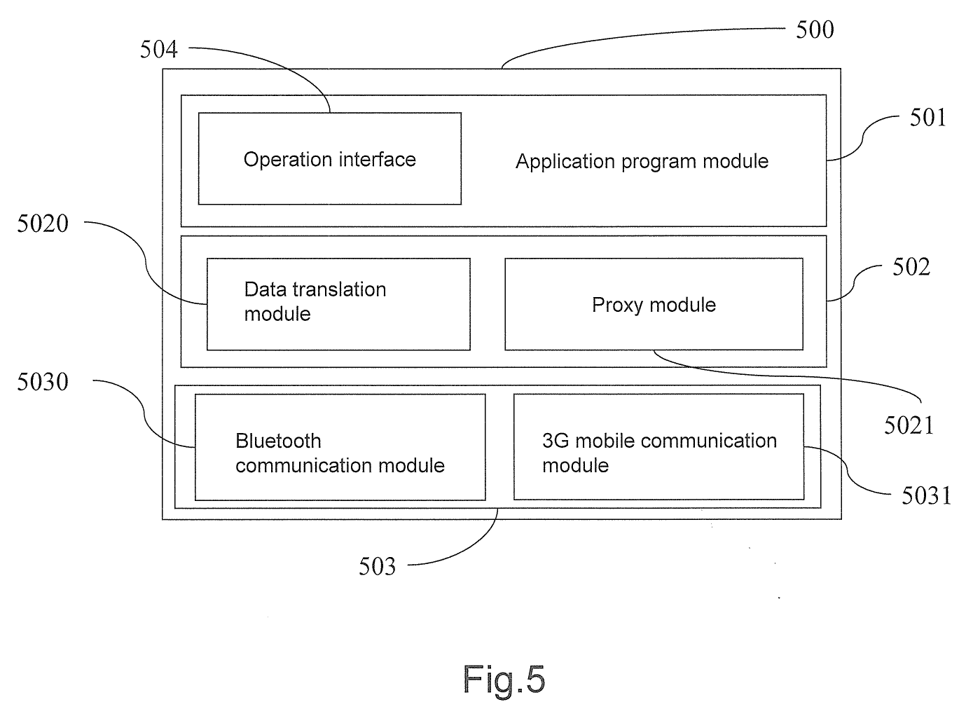

FIG. 5 is a block diagram of a cell phone supporting the power saving method in FIG. 3. The cell phone 500 includes an application program module 501, a control module 502, and a dual mode communication module 503. The application program module 501 has an operation interface 504. The dual mode communication module 503 has a Bluetooth communication module 5030 and a 3G mobile communication protocol module 5031. The control module 502 has a data translation module 5020 and a proxy module 5021.

When the cell phone 500 enters a vehicle environment, the control module 502 controls the Bluetooth communication module 5030 to establish a connection between the cell phone 500 and a vehicle gateway according to the Bluetooth communication protocol. If a connection established according to the 3G mobile communication protocol exists between the cell phone 500 and an access point, the control module 502 controls the 3G mobile communication protocol module 5031 to cut off the connection established according to the 3G mobile communication protocol between the cell phone 500 and the access point. A user operates the operation interface 504 of the application program module 501 so that the cell phone 500 communicates with the access point through the vehicle gateway.

When the connection between the cell phone 500 and the vehicle gateway is established, the cell phone 500 transmits a SIM profile of the cell phone 500 and related user data to the vehicle gateway automatically or according to a request of the vehicle gateway through the connection established according to the Bluetooth communication protocol. After receiving the SIM profile of the cell phone 500 and the user data, the vehicle gateway transmits the SIM profile of the cell phone 500 and the user data to the access point through the connection established according to the 3G mobile communication protocol. Thus, the vehicle gateway poses as the cell phone 500, and the access point considers the vehicle gateway as the cell phone 500.

Besides controlling the dual mode communication module 503 and managing the connections established by the dual mode communication module 503, the data translation module 5020 of the control module 502 also receives data transmitted by the access point through the vehicle gateway and converts the format of the data into a format specified by the 3G mobile communication protocol, so that different application programs in the application program module 501 can use the data transmitted by the access point through the vehicle gateway without altering the application programs in the application program module 501. Similarly, the data translation module 5020 also receives data transmitted by the cell phone 500 through the vehicle gateway and converts the format of the data into a format specified by the Bluetooth mobile communication protocol so that the vehicle gateway can receive the data transmitted through the connection established according to the Bluetooth mobile communication protocol.

Before the cell phone 500 enters the vehicle environment, the cell phone 500 directly connects to and communicates with the access point according to the 3G mobile communication protocol. Thus, the proxy module 5021 transmits data from the 3G mobile communication protocol module 5031 to the application program module 501 and from the application program module 501 to the 3G mobile communication protocol module 5031. When the cell phone 500 enters the vehicle environment, the cell phone 500 communicates with the access point through the vehicle gateway. Thus, the proxy module 5021 transmits the converted data from the data translation module 5020 to the application program module 501 and the data from the application program module 501 to the data translation module 5020.

The control module 502 and the operation interface 504 may be implemented as hardware circuits or software programs. For example, an existing cell phone 500 usually has a processing unit and a storage unit. The storage unit stores a plurality of program codes, and the processing unit reads and executes these program codes to accomplish the functions of the control module 502 and the operation interface 504.

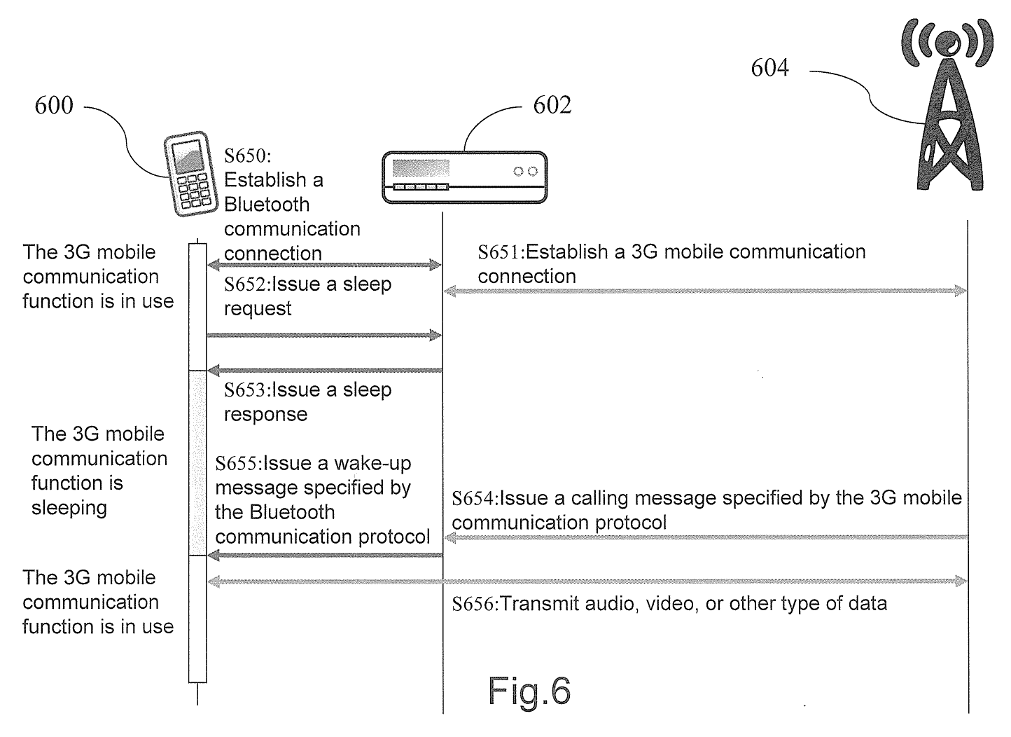

FIG. 6 is a flowchart of a power saving method of a mobile device according to another exemplary embodiment of the present invention. Referring to FIG. 6, the steps S650-S653 are the same as the steps S350-S353 illustrated in FIG. 3, and therefore they will not be described herein. After step S653, when an access point 604 is about to communicate with the cell phone 600, a calling message specified by the 3G mobile communication protocol is issued by the access point 604 to the vehicle gateway 602 (step S654). After the vehicle gateway 602 receives the calling message from the access point 604, a wake-up message specified by the Bluetooth communication protocol is issued by the vehicle gateway 602 to the cell phone 600 according to the calling message, so as to instruct the cell phone 600 to re-establish or resume the connection established between the cell phone 600 and the access point 604 according to the 3G mobile communication protocol (step S655). After the cell phone 600 re-establishes or resumes the connection between the cell phone 600 and the access point 604 established according to the 3G mobile communication protocol (i.e., a 3G mobile communication protocol module of the cell phone 600 switches from a sleep state to a working state), the access point 604 directly transmits data (for example, audio, video, or other type of data) to the cell phone 600 through the connection established between the cell phone 600 and the access point 604 according to the 3G mobile communication protocol (step S656).

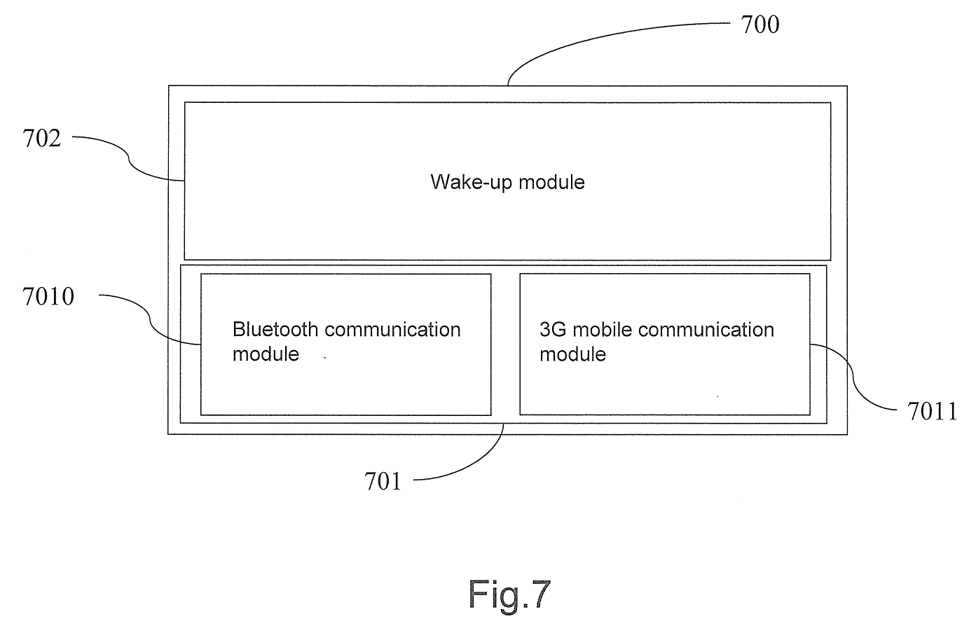

In the example described above, the vehicle gateway 602 has a wake-up module for generating a wake-up message for the cell phone 600 according to a received calling message. FIG. 7 is a block diagram of a vehicle gateway supporting the power saving method in FIG. 6. Referring to FIG. 7, the vehicle gateway 700 includes a dual mode communication module 701 and a wake-up module 702. The dual mode communication module 701 has a Bluetooth communication module 7010 and a 3G mobile communication protocol module 7011. The Bluetooth communication module 7010 and the 3G mobile communication protocol module 7011 illustrated in FIG. 7 are respectively the same as the Bluetooth communication module 3010 and the 3G mobile communication protocol module 3011 illustrated in FIG. 3, and therefore they will not be described herein.

When the vehicle gateway 700 receives a calling message from an access point, the wake-up module 702 generates a wake-up message according to the calling message and sends the wake-up message to the cell phone. After the cell phone receives the wake-up message, the cell phone re-establish or resume a connection established between the cell phone and the access point according to the 3G mobile communication protocol. After that, the access point directly transmits data to the cell phone through the connection established between the cell phone and the access point according to the 3G mobile communication protocol. Besides, the wake-up module 702 may be implemented as a hardware circuit or a software program.

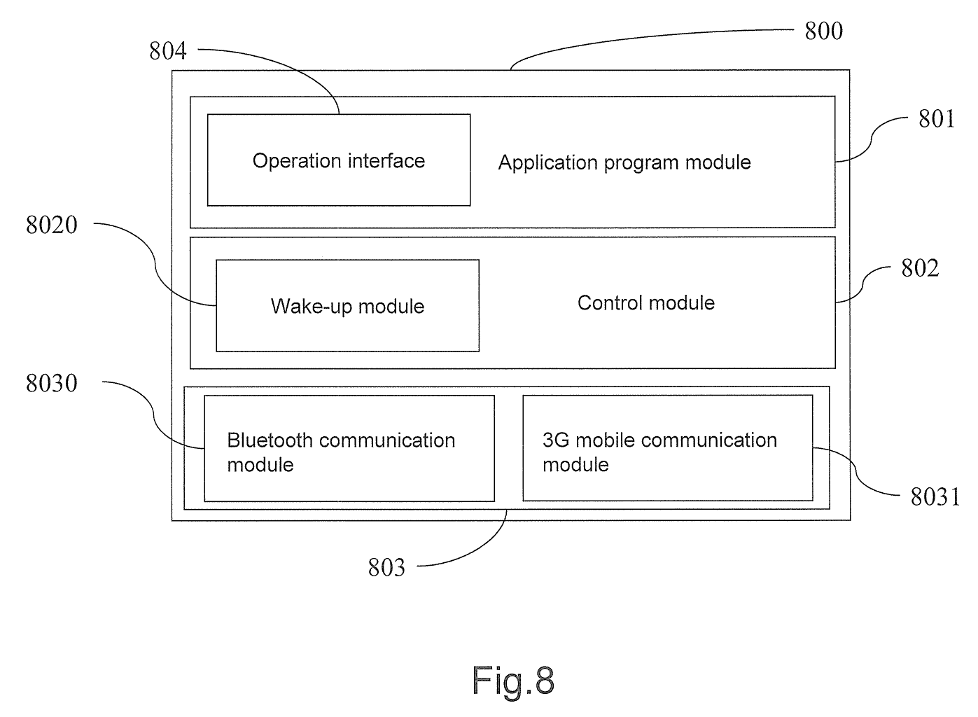

FIG. 8 is a block diagram of a cell phone supporting the power saving method in FIG. 6. The cell phone 800 includes an application program module 801, a control module 802, and a dual mode communication module 803. The application program module 801 has an operation interface 804. The dual mode communication module 803 has a Bluetooth communication module 8030 and a 3G mobile communication protocol module 8031. The control module 802 further has a wake-up module 8020.

When the cell phone 800 enters a vehicle environment, the control module 802 controls the Bluetooth communication module 5030 to establish a connection between the cell phone 800 and a vehicle gateway according to the Bluetooth communication protocol. If a connection established according to the 3G mobile communication protocol exists between the cell phone 800 and an access point, the control module 802 controls the 3G mobile communication protocol module 8031 to cut off the connection established according to the 3G mobile communication protocol between the cell phone 800 and the access point. The user operates the operation interface 804 in the application program module 801 to allow the cell phone 800 to communicate with the access point through the vehicle gateway.

When the connection between the cell phone 800 and the vehicle gateway is established, the cell phone 800 transmits a SIM profile of the cell phone 800 and related user data to the vehicle gateway automatically or according to a request of the vehicle gateway through the connection established according to the Bluetooth communication protocol. After the vehicle gateway receives the SIM profile of the cell phone 800 and the user data, it transmits the SIM profile of the cell phone 800 and the user data to the access point through the connection established according to the 3G mobile communication protocol. Thus, the vehicle gateway poses as the cell phone 800, and the access point considers the vehicle gateway as the cell phone 800.

When the access point is about to transmit data to the cell phone 800, the access point issues a calling message to the vehicle gateway through the connection established between the access point and the vehicle gateway according to the 3G mobile communication protocol. Then, the vehicle gateway generates a wake-up message according to the calling message and sends the wake-up message to the cell phone 800. The Bluetooth communication module 8030 of the cell phone 800 receives the wake-up message and sends the wake-up message to the wake-up module 8020. When the wake-up module 8020 receives the wake-up message, it instructs the control module 802 to control the 3G mobile communication protocol module 8031 to establish a connection between the cell phone 800 and the access point according to the 3G mobile communication protocol. After the connection between the cell phone 800 and the access point is established according to the 3G mobile communication protocol, the cell phone 800 receives the data from the access point through the connection between the cell phone 800 and the access point established according to the 3G mobile communication protocol.

The control module 802 and the operation interface 804 may be implemented as hardware circuits or software programs. In another exemplary embodiment, the control module of the cell phone 800 may have a wake-up module, a data translation module, and a proxy module to support both the power saving method illustrated in FIG. 3 and the power saving method FIG. 6.

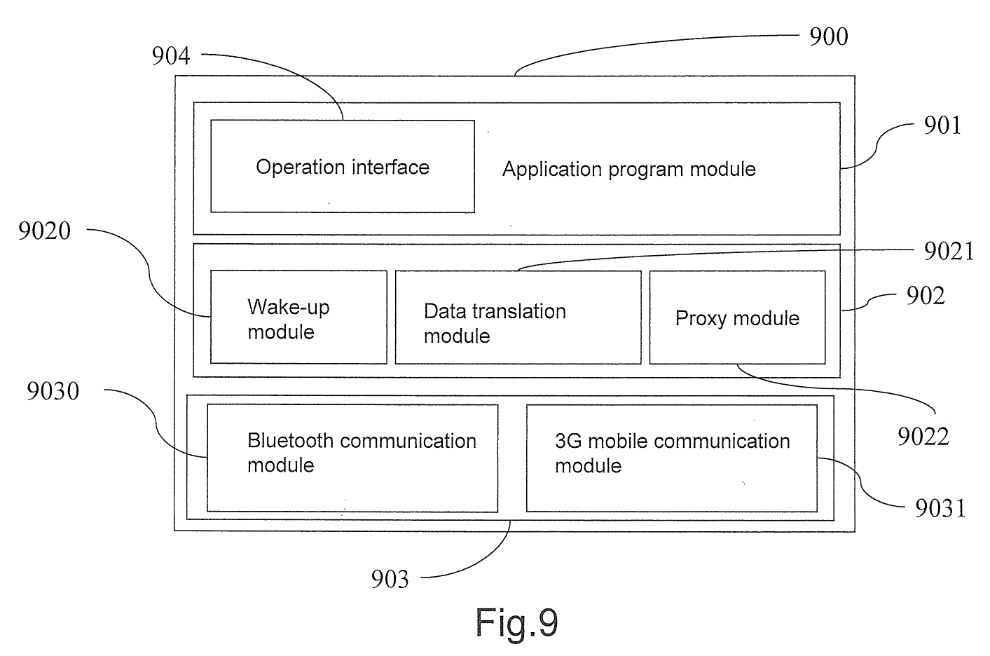

FIG. 9 is a block diagram of a cell phone supporting both the power saving method in FIG. 3 and the power saving method in FIG. 6. Referring to FIG. 9, the cell phone 900 includes an application program module 901, a control module 902, and a dual mode communication module 903. The application program module 901 has an operation interface 904. The dual mode communication module 903 has a Bluetooth communication module 9030 and a 3G mobile communication protocol module 9031. The control module 902 has a wake-up module 9020, a data translation module 9021, and a proxy module 9022.

The functions of the application program module 901, the operation interface 904, the control module 902, the dual mode communication module 903, the Bluetooth communication module 9030, the 3G mobile communication protocol module 9031, the wake-up module 9020, the data translation module 9021, and the proxy module 9022 have been described in detail above, and therefore they will not be described herein.

In summary, in the power saving method provided by an exemplary embodiment of the present invention, the power consumption of a mobile device is reduced. When the mobile device is located in a travel-by-vehicle environment, the mobile device can be connected to a communication device through a low-power transmission mode. A SIM profile of the mobile device and other related user data is relayed to an access point through the communication device so that the communication device is not considered as an earphone, a microphone, or a cell phone peripheral device. As to the access point, it considers the communication device as the mobile device itself as directly communicating with the mobile device. Thus, the access point does not know about the existence of the communication device. Accordingly, a user can use the mobile device in the travel-by-vehicle environment without changing his his original operation habit. Besides, the manufacturer of the mobile device does not need to alter various application programs in the mobile device.

Moreover, in another exemplary embodiment, a communication device with a wake-up mode is provided for an exemplary embodiment of a low-level vehicle gateway. Accordingly, a mobile device in an exemplary embodiment of the present invention has a dual mode communication module and a control module. The control module manages a plurality of connections of the mobile device. Besides, if aforementioned control module of the mobile device is also disposed, the control module can be implemented as an application program on some mobile device platforms through data packet redirection and simulated voice port. Thereby, the existing structure of the mobile device needs not be changed too much, and this makes the technique provided by the present invention very practical.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power saving method, adaptable to a mobile device in a travel-by-vehicle environment, the power saving method comprising:
establishing a connection between the mobile device and a communication device according to a first communication protocol;
establishing a connection between an access point and the communication device according to a second communication protocol, wherein a transmission power required in the first communication protocol is lower than a transmission power required in the second communication protocol;
when a connection established according to the second communication protocol exists between the mobile device and the access point, cutting off the connection established according to the second communication protocol between the mobile device and the access point; and
providing an operation interface of the mobile device to a user to operate, such that the mobile device communicates with the access point through the communication device.

2. The power saving method according to claim 1, wherein in the connection between the mobile device and the communication device, the mobile device works as a client, and the communication device works as a server, the first communication protocol is a short distance wireless communication protocol, and the second communication protocol is a medium/long distance wireless communication protocol, the travel-by-vehicle environment is a vehicle environment, and the communication device is a proxy server, a gateway, or a repeater in a transportation vehicle taken by the user.

3. The power saving method according to claim 1, wherein in the step of establishing the connection between the mobile device and the communication device, the communication device obtains a subscriber identity module (SIM) profile of the mobile device and a user data from the mobile device, such that the communication device poses as the mobile device and the access point considers the communication device as the mobile device.

4. The power saving method according to claim 1, wherein the mobile device and the communication device respectively have a dual mode communication module, and the dual mode communication module is capable of establishing a connection according to the first communication protocol or the second communication protocol.

5. The power saving method according to claim 1, wherein when the mobile device communicates with the access point through the communication device, the communication device relays a first communication data from the mobile device to the access point and relays a second communication data from the access point to the mobile device.

6. The power saving method according to claim 1 further comprising:
sending a calling message to the communication device by using the access point when the access point is about to transmit a first communication data to the mobile device;
generating a wake-up message according to the calling message and sending the wake-up message to the mobile device by using the communication device; and
connecting to the access point according to the second communication protocol when the mobile device receives the wake-up message, and receiving the first communication data after the connection between the mobile device and the access point is established.

7. A non-volatile storage medium, for storing a plurality of program codes, wherein the program codes are executed to run the power saving method in claim 1.

8. A mobile device, adaptable to a travel-by-vehicle environment, the mobile device comprising:
an operation interface;
a control module; and
a dual mode communication module, capable of establishing a connection according to a first communication protocol or a second communication protocol, wherein a transmission power required in the first communication protocol is lower than a transmission power required in the second communication protocol;
wherein when the mobile device enters the travel-by-vehicle environment,
the control module controls the dual mode communication module to establish a connection between the mobile device and a communication device according to the first communication protocol;
when a connection established according to the second communication protocol exists between the mobile device and an access point, the control module controls the dual mode communication module to cut off the connection established according to the second communication protocol between the mobile device and the access point; and
a user operates the operation interface so that the mobile device communicates with the access point through the communication device, wherein a connection is established between the communication device and the access point according to the second communication protocol.

9. The mobile device according to claim 8, wherein in the connection between the mobile device and the communication device, the mobile device works as a client, and the communication device works as a server, the first communication protocol is a short distance wireless communication protocol, and the second communication protocol is a medium/long distance wireless communication protocol, the travel-by-vehicle environment is a vehicle environment, and the communication device is a proxy server, a gateway, or a repeater in a transportation vehicle taken by the user.

10. The mobile device according to claim 8, wherein when the connection between the mobile device and the communication device is established, the communication device obtains a SIM profile of the mobile device and a user data from the mobile device, such that the communication device poses as the mobile device and the access point considers the communication device as the mobile device.

11. The mobile device according to claim 8, wherein when the mobile device communicates with the access point through the communication device, the communication device relays a first communication data from the mobile device to the access point and relays a second communication data from the access point to the mobile device.

12. The mobile device according to claim 8, wherein when the mobile device receives a wake-up message from the communication device, the mobile device connects with the access point according to the second communication protocol and receives a communication data from the access point after a connection between the mobile device and the access point is established.

13. A communication device, adaptable to a travel-by-vehicle environment, the communication device comprising:
a translation module; and
a dual mode communication module, capable of establishing a connection according to a first communication protocol or a second communication protocol, wherein a transmission power required in the first communication protocol is lower than a transmission power required in the second communication protocol;
wherein when a mobile device enters the travel-by-vehicle environment,
the dual mode communication module establishes a connection between the mobile device and the communication device according to the first communication protocol;
the dual mode communication module establishes a connection between an access point and the communication device according to the second communication protocol; and
after cutting off a connection established according to the second communication protocol between the mobile device and the access point, a user operates an operation interface of the mobile device so that the mobile device communicates with the access point through the communication device, and the translation module relays a first communication data from the mobile device to the access point and relays a second communication data from the access point to the mobile device.

14. The communication device according to claim 13, wherein the translation module converts a format of a first communication data received from the mobile device into a format specified by the second communication protocol and relays the converted first communication data to the access point, and the translation module converts a format of a second communication data received from the access point into a format specified by the first communication protocol and relays the converted second communication data to the mobile device.

15. The communication device according to claim 13, wherein in the connection between the mobile device and the communication device, the mobile device works as a client, and the communication device works as a server, the first communication protocol is a short distance wireless communication protocol, and the second communication protocol is a medium/long distance wireless communication protocol.

16. The communication device according to claim 13, wherein when the connection between the mobile device and the communication device is established, the communication device obtains a SIM profile of the mobile device and a user data from the mobile device, such that the communication device poses as the mobile device and the access point considers the communication device as the mobile device.

17. A communication device, adaptable to a travel-by-vehicle environment, the communication device comprising:
a wake-up module; and
a dual mode communication module, capable of establishing a connection according to a first communication protocol or a second communication protocol, wherein a transmission power required in the first communication protocol is lower than a transmission power required in the second communication protocol;
wherein when a mobile device enters the travel-by-vehicle environment,
the dual mode communication module establishes a connection between the mobile device and the communication device according to the first communication protocol;
the dual mode communication module establishes a connection between an access point and the communication device according to the second communication protocol;
after cutting off a connection established according to the second communication protocol between the mobile device and the access point, a user operates an operation interface of the mobile device so that the mobile device communicates with the access point through the communication device; and
when the communication device receives a calling message from the access point, the wake-up module generates a wake-up message according to the calling message and sends the wake-up message to the mobile device.

18. The communication device according to claim 17, wherein the access point sends the calling message to the communication device when the access point is about to transmit a first communication data to the mobile device, the mobile device connects with the access point according to the second communication protocol when the mobile device receives the wake-up message, and the mobile device receives the first communication data after the connection is established between the mobile device and the access point.

19. The communication device according to claim 17, wherein in the connection between the mobile device and the communication device, the mobile device works as a client, and the communication device works as a server, the first communication protocol is a short distance wireless communication protocol, and the second communication protocol is a medium/long distance wireless communication protocol.

20. The communication device according to claim 17, wherein when the connection between the mobile device and the communication device is established, the communication device obtains a SIM profile of the mobile device and a user data from the mobile device, such that the communication device poses as the mobile device and the access point considers the communication device as the mobile device.

21. A communication system, comprising:
a mobile device, located in a travel-by-vehicle environment;
a communication device, also located in the travel-by-vehicle environment;
an access point;
wherein the mobile device and the communication device establish a connection with each other according to a first communication protocol, the communication device and the access point establish a connection with each other according to a second communication protocol, and a transmission power required in the first communication protocol is lower than a transmission power required in the second communication protocol, when a connection established according to the second communication protocol exists between the mobile device and the access point, the connection established according to the second communication protocol between the mobile device and the access point is cut off, and an operation interface of the mobile device is provided to a user to operate, such that the mobile device communicates with the access point through the communication device.

22. The communication system according to claim 21, wherein when the connection between the mobile device and the communication device is established, the communication device obtains a SIM profile of the mobile device and a user data from the mobile device, such that the communication device poses as the mobile device and the access point considers the communication device as the mobile device.

23. The communication system according to claim 22, wherein when the mobile device communicates with the access point through the communication device, the communication device relays a first communication data from the mobile device to the access point and relays a second communication data from the access point to the mobile device.

24. The communication system according to claim 21, wherein a calling message is sent to the communication device by the access point when the access point is about to transmit a first communication data to the mobile device; a wake-up message is generated according to the calling message and sending the wake-up message to the mobile device by the communication device; and a connection with the access point according to the second communication protocol is established by the mobile device when the mobile device receives the wake-up message, and the first communication data is received by the mobile device after the connection between the mobile device and the access point is established.
